(19) United States
(12) Patent Application Publication
(10) Pub. No.: US 2026/0359917 A1
(43) Pub. Date: Nov. 12, 2026

(54) SYSTEM AND METHOD FOR ALIGNING ACADEMIC CURRICULA WITH INDUSTRY SKILL REQUIREMENTS USING LARGE LANGUAGE MODELS AND DYNAMIC TALENT ANALYTICS

(71) Applicant: NormIP LLC

(72) Inventor: Jorge Gabriel Normandia Urbina

(73) Assignee: NormIP LLC, (US)

(21) Appl. No.: 19/670,712

(22) Filed: May 7, 2026

Related U.S. Application Data
(60) Provisional application No. 63/802,546, filed on May 8, 2025.

(51) Int. Cl. G06Q 50/20; G06Q 10/0631

(52) U.S. Cl. CPC G06Q 50/2057; G06Q 10/063112

(57) ABSTRACT

A system and method are provided to align academic course content with the skills and knowledge currently required by the industry. The system includes an analysis component that evaluates industry process documentation to identify necessary skills and knowledge. An alignment component then compares these requirements with educational content using an assessment matrix, ranking course descriptions by their relevance. A trend identification component detects changes in skill requirements over time, while a review component manages course descriptions with low relevance scores. The method support curriculum development and industry collaboration by facilitating the storage and access of academic and industry information. The system may further apply the same skills extraction and alignment pipeline to professional candidate profiles and to workforce development training tracks, returning to an enterprise dashboard separate ranked lists of professionals and of institution programs and workforce development training tracks.

### CROSS-REFERENCE TO RELATED APPLICATIONS

This application claims the benefit of U.S. Provisional Application No. 63/802,546, filed May 08, 2025, entitled “A System and Method to Enhance Alignment of Course Content with Evolving Industry Requirements,” the entire contents of which are incorporated herein by reference.

### STATEMENT REGARDING FEDERALLY SPONSORED RESEARCH AND DEVELOPMENT

Not Applicable.

### BACKGROUND

### Field of the Invention

The present disclosure relates to computer‑implemented systems and methods for aligning educational curricula with industry skill and knowledge requirements. It more particularly concerns techniques for analyzing industry skill signals and operational process documentation, normalizing those requirements into a standardized skills taxonomy, and dynamically mapping the normalized requirements to academic programs, courses, and enrolled students to support curriculum optimization and talent acquisition.

### Existing Technologies and Challenges

Over the last decade, the gap between the skills taught in academic programs and the skills demanded by employers has become increasingly pronounced across technology, healthcare, manufacturing, logistics, and other sectors. Traditional mechanisms for capturing industry needs—such as periodic surveys, advisory boards, and static job descriptions—are typically infrequent, labor‑intensive to administer, and slow to reflect emerging tools, platforms, and practices. On the academic side, curricula, syllabi, and course catalogs are often managed in disconnected systems, described using institution‑specific terminology, and updated on multi‑year cycles, making it difficult to determine in a structured, machine‑readable way which concrete skills a given program actually imparts. As a result, employers must often infer a candidate’s capabilities from proxies such as degrees and course titles, while institutions lack timely, quantitative feedback about how well their offerings align with current and future workforce needs.

Existing hiring and education technologies only partially address this misalignment. Job boards, applicant tracking systems, and skills‑tagging tools allow employers to post openings and filter resumes using keyword‑based search or generic skills taxonomies, but they generally treat job descriptions and profiles as unstructured text and do not maintain a normalized, cross‑institution skills model that can be compared against specific curricular elements and real‑time student progress. Learning management systems and student information systems maintain course enrollments and grades, yet they rarely encode course outcomes in terms of discrete, standardized skills that can be directly matched to externally defined requirements. Consequently, any connection between employer demand signals and academic content tends to be manual, ad hoc, and difficult to scale across large numbers of programs and job types.

While recent advances in large language models and other AI‑based text analytics enable the extraction of fine‑grained skills from job postings, requisitions, and Standard Operating Procedures (SOPs), conventional tools typically use these capabilities only to improve search or recommendation within a single domain, such as matching candidates to jobs. They do not persistently reconcile diverse employer terminology into a master skills database, compute program‑level alignment scores, expose ranked program lists with associated student completion data to enterprise users, or aggregate historical interaction data into institution‑facing “gap” views that highlight missing or emerging skills by industry classification and job title. As a result, information derived from employer artifacts is seldom fed back into curriculum design and institutional planning, leaving a need for a computer‑implemented platform that integrates AI‑driven skill extraction, curriculum mapping, student tracking, and analytics into a closed‑loop feedback system connecting industry, institutions, and students.

### SUMMARY

The system is designed to include an analysis component that can thoroughly examine industry operational process documentation to pinpoint the essential skills and knowledge required for various operational processes. This documentation often contains detailed insights into these processes. An alignment component plays a crucial role by comparing the identified skills and knowledge with educational content from courses, using an alignment assessment matrix to determine how relevant they are. This matrix offers a structured method for evaluating how well the skills and knowledge requirements align with the educational content. Based on the relevance scores, the alignment component can rank and list multiple course descriptions accordingly. Additionally, a trend identification component is capable of spotting trends in skill and knowledge requirements by analyzing patterns and changes in the operational processes over time, as revealed by the industry documentation. If a course description's relevance score falls below a certain threshold, a review component can move the related industry documentation to an academic review repository (522) for further examination.

Industry users can upload operational process documentation, while academic users contribute course educational content covering a wide range of topics and competencies. The system features a storage and access component, embodied at least in part by the Relational Database Server (150) of FIG. 1, that securely stores both academic course information and industry documentation, ensuring users can access the analysis, alignment, and trend identification functionalities. The academic review repository is accessible to academic users, allowing them to review documentation and potentially develop new curricula based on the findings.

To identify trends in skill and knowledge requirements, the system examines how often these requirements appear and how they change over time within industry documentation. Using the alignment assessment matrix, the system evaluates how well the identified skills align with course content. The analysis component can access industry documentation either from a data repository or directly, while the alignment component can similarly receive academic course information. This process involves several steps: analyzing industry documentation to pinpoint necessary skills and knowledge, comparing these with course content using the alignment matrix, ranking course descriptions based on their relevance, identifying trends, and finally, determining if a course description's relevance score is low enough to warrant moving the documentation to an academic review repository.

In further aspects, the platform additionally leverages the same skills extraction and normalization pipeline to support enterprise talent acquisition beyond institution programs. Once the platform has identified and normalized the skills required by an enterprise from industry operational process documentation, the platform may apply the same alignment assessment to (i) experienced professional candidates, including independent professionals who maintain their own profiles on the platform, and (ii) candidates participating in workforce development programs offered by workforce development partners. Workforce development partners are treated analogously to learning institutions, with their training tracks compared in the same manner as institution programs. The Enterprise Dashboard (410) is configured to return, for a given enterprise request, two separate ranked lists: a first list of candidates comprising independent professionals and other professionals identified through the platform, and a second list of institution programs and workforce development training tracks aligned to the enterprise's skills and knowledge requirements.

### BRIEF DESCRIPTION OF THE FIGURES

The accompanying drawings illustrate various embodiments and along with the description, help explain the principles of the method. It is understood by those skilled in the art that the specific arrangements shown in the drawings are merely examples and should not be considered as limiting the scope of the method or the claims in any way.

FIG. 1 is a deployment architecture diagram of an Academic-Industry Alignment Platform

FIG. 2 illustrates an Analysis Component the platform

FIG. 3 illustrates an Alignment Component

FIG. 4 illustrates an end-to-end process flow across an Enterprise User and an Enterprise Dashboard the Alignment Platform and Application Server and a Learning Institution and Institution Dashboard

FIG. 5 illustrates a Trend Identification Component and a Gap Analysis Component

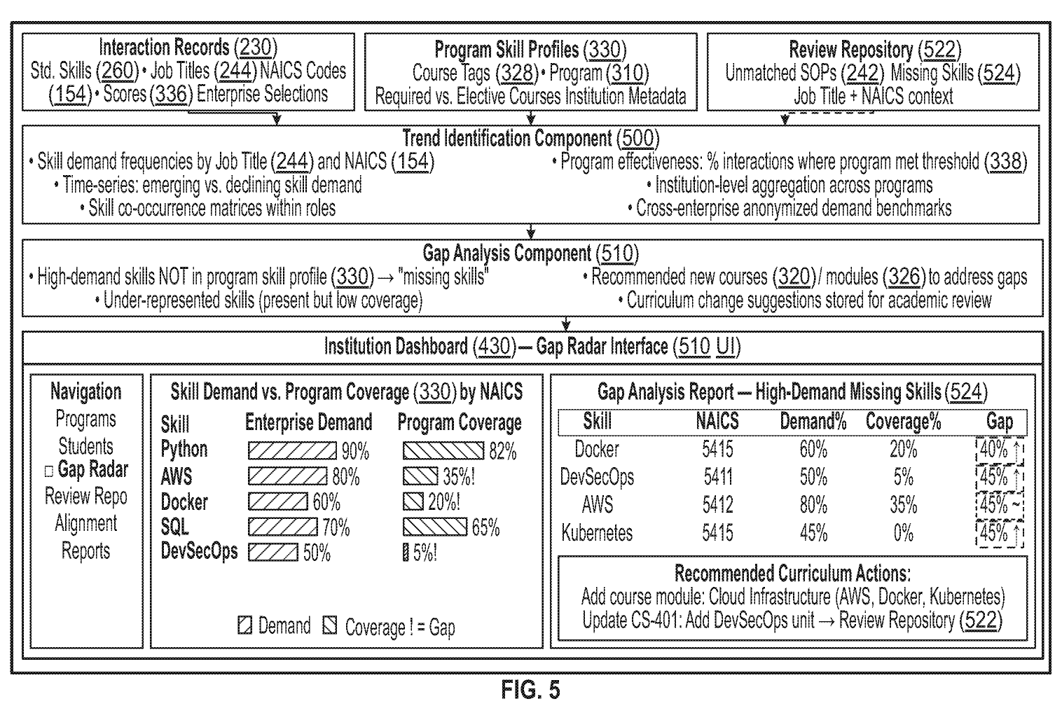

FIG. 6 illustrates an Enterprise Dashboard Talent Search Results view

### DETAILED DESCRIPTION

The following detailed description is provided to illustrate various nonlimiting embodiments of the system for aligning academic course content with current industry skill and knowledge requirements. The description refers to specific components, processes, and configurations for illustrative purposes only. The system is not limited to the specific embodiments disclosed herein and may include variations, modifications, and equivalents as understood by those skilled in the art. Unless expressly indicated otherwise, the singular forms “a,” “an,” and “the” include plural references, and use of “includes,” “comprises,” or “having” is intended to be inclusive and not limiting. This flexibility allows the system to adapt to a wide range of educational and industry contexts, ensuring its applicability across different sectors and disciplines. For instance, the system can be tailored to align courses in fields such as engineering, healthcare, information technology, and business management with the latest industry standards and practices.

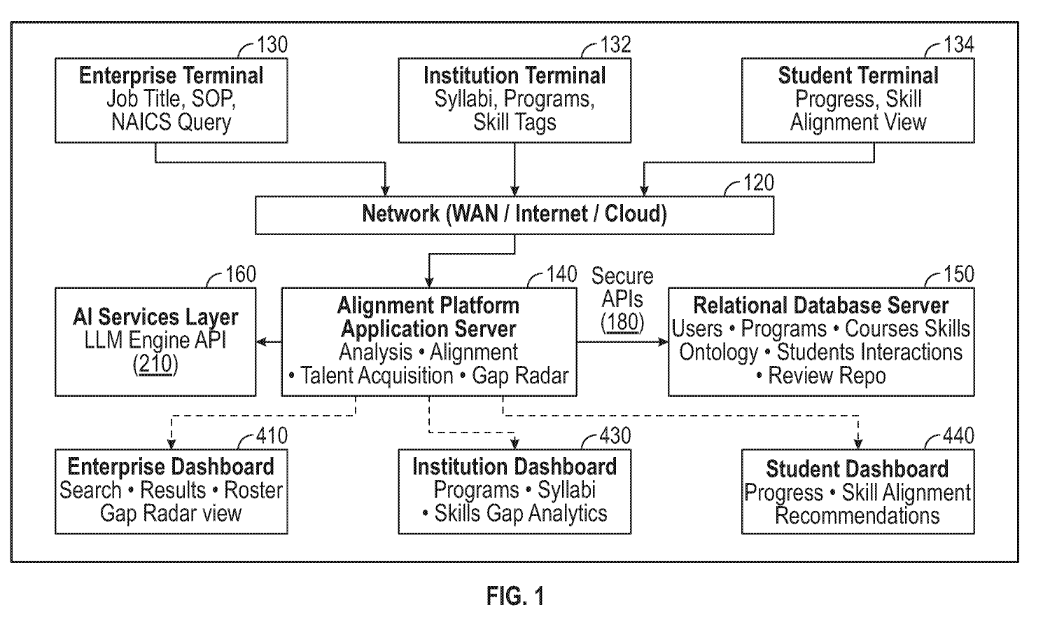

Turning now to FIG. 1, an Academic-Industry Alignment Platform (100) is shown as a computer-implemented platform executing on one or more processors and memories that includes an Alignment Platform Application Server (140) executing an Analysis Component (200), an Alignment Component (300), a Talent Acquisition Component (350), and a Gap Radar function, in communication with a Relational Database Server (150) and an AI Services Layer (160) that hosts a Large Language Model (LLM) Engine API (210). The platform (100) is accessed by an Enterprise Terminal (130), an Institution Terminal (132), and a Student Terminal (134) over a Network (120) (e.g., a LAN, WAN, the Internet, or a cloud network) using Secure APIs (180), and serves an Enterprise Dashboard (410), an Institution Dashboard (430), and a Student Dashboard (440). The system is preferably implemented via one or more interconnected computing devices, including cloud servers, user terminals, and local computing environments, with communication facilitated through networks such as LAN, WAN, or the Internet. This interconnectedness ensures seamless data flow and real-time updates, allowing for dynamic adjustments to course content based on the latest industry trends. The system enables interactions between distinct user groups including educators, learners, and administrators to achieve adaptive curriculum development and industry relevance. For example, educators can use the platform to update course materials to reflect new industry certifications, while learners can access personalized learning paths that align with their career goals. Administrators can leverage the system to ensure that the institution's offerings remain competitive and aligned with market demands.

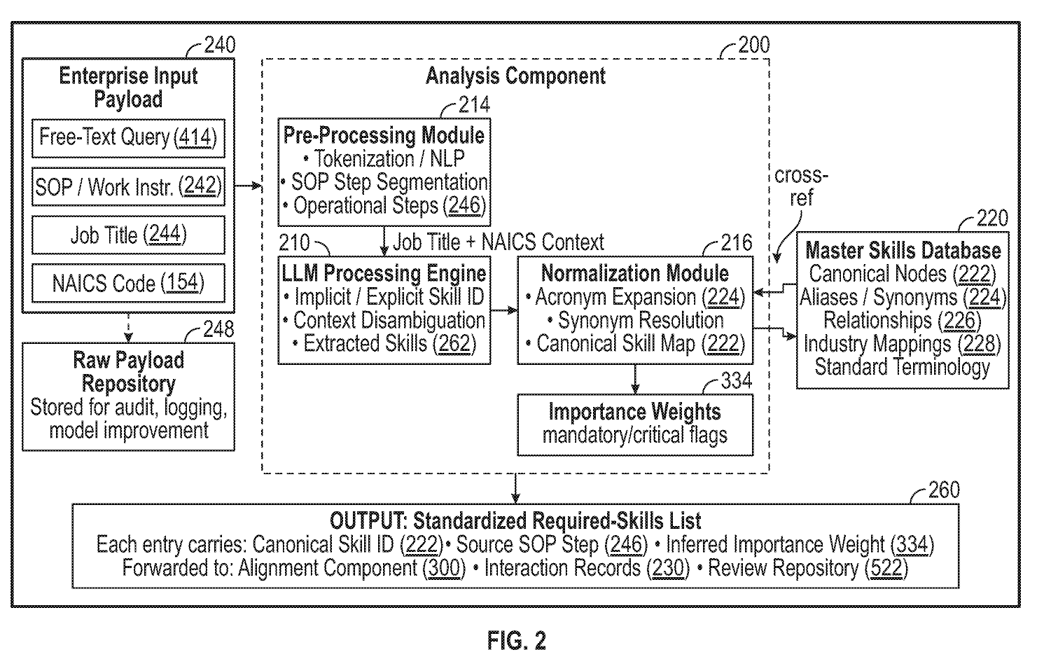

Referring to FIG. 2, the Analysis Component (200) includes a hierarchy of modules comprising a Pre-Processing Module (214), an LLM Processing Engine (210), and a Normalization Module (216), which in this disclosure are also referred to respectively as a Data Acquisition Module, a Data Validation Module, and a Skills and Knowledge Identification Module. These modules coordinate under a structured pipeline that automatically transforms raw, heterogeneous machine-readable and human-authored industry documentation into standardized, machine-interpretable skills data structures usable by the rest of the platform.

The Data Acquisition Module is designed to efficiently gather, organize, and verify a wide range of data types from various sources, ensuring comprehensive data collection. It utilizes advanced techniques to handle both structured and unstructured data, drawing from APIs for seamless integration with external systems, web sources for publicly available information, and internal databases for proprietary data. The module employs web scraping to extract information from websites, capturing data that isn't accessible through APIs, while API data ingestion allows for direct and efficient collection from external services, keeping the information up-to-date. Real-time database queries provide access to the most current data from internal systems, ensuring the analysis is based on the latest information. To maintain accuracy, cross-validation error checking is used to verify the data's consistency, identifying and correcting any discrepancies. This comprehensive approach ensures that the data collected is both accurate and relevant, providing a solid foundation for further analysis and alignment processes. By integrating these diverse methods, the Data Acquisition Module supports the system's goal of aligning academic course content with industry requirements, ensuring that the insights derived are based on reliable and current data.

The Pre-Processing Module (214) performs concrete text-processing operations that prepare industry operational process documentation for downstream machine analysis. When the module receives an Enterprise Input Payload (240) containing standard operating procedures, work instructions, or free-text queries, it applies tokenization to break the unstructured text into words, phrases, and sentences using natural language processing routines. The module identifies sentence boundaries, separates punctuation, and creates a structured representation of the input text that enables subsequent semantic analysis by the LLM Processing Engine (210).

For standard operating procedures specifically, the Pre-Processing Module performs step segmentation by identifying sequential operational steps within the documentation. This segmentation process may use pattern recognition to detect step markers such as numbered lists, action verbs, temporal indicators, and procedural structure signals. Each identified operational step may be extracted as a discrete text segment representing a coherent unit of work within the overall process. By segmenting lengthy standard operating procedures into discrete operational steps, the Pre-Processing Module reduces computational processing requirements for the downstream LLM Processing Engine (210) by limiting the input context length presented for each analysis operation. Rather than processing an entire multi-page document as a single context window, the system may process each operational step independently. This segmentation approach improves extraction accuracy by focusing the language model on specific procedural tasks rather than requiring it to maintain context across an entire lengthy document, thereby providing a specific improvement to computer processing of long technical documents.

The Data Validation Module is essential for maintaining the integrity and usability of data within the system, performing several key functions to transform raw data into formats suitable for analytics and system integration. It begins by cleaning the data, removing errors, inconsistencies, or irrelevant information that could affect analysis accuracy, including duplicate removal to prevent redundancy and ensure each data point is unique. The module enriches data by adding contextual information through metadata, providing relevant context that enhances its value and usability. Schema normalization is another critical function, standardizing data into a consistent format to facilitate seamless integration and analysis, allowing different data sets to be combined and compared without compatibility issues. Additionally, the module performs aggregation for holistic analytics, combining data from multiple sources to provide a comprehensive view of industry trends. This aggregation enables more informed decision-making by allowing users to see the bigger picture and identify patterns or trends not apparent from individual data sets. This holistic approach to data analysis is vital for understanding complex industry dynamics and making strategic decisions based on accurate and complete information.

The Normalization Module (216), also referred to in certain embodiments as a Skills and Knowledge Identification Module, transforms the Extracted Skills (262) identified by the LLM Processing Engine (210) into standardized canonical skill identifiers stored in a Master Skills Database (220). The module may maintain an acronym dictionary that maps abbreviations and acronyms to corresponding full terminology. When the module encounters an acronym in the Extracted Skills (262), it may perform acronym expansion by querying the acronym dictionary and replacing abbreviated terms with full forms so that skills are represented consistently regardless of how they appeared in the source documentation.

The Normalization Module further performs synonym resolution using the Master Skills Database (220) and an associated skills ontology. The skills ontology may define a hierarchical structure in which each Canonical Skill Node (222) may have parent nodes, child nodes, sibling nodes, and a set of Aliases and Synonyms (224) representing variant terminology that maps to the same canonical concept. The normalization process may traverse the hierarchical relationships in the skills ontology by comparing each extracted skill against aliases and synonyms associated with Canonical Skill Nodes (222). When a match is found, whether through exact comparison or fuzzy matching that accounts for spelling variations and terminology differences, the extracted skill may be mapped to the corresponding canonical skill identifier. This automated normalization reduces the need for manual reconciliation of different terminology used by different enterprises and industries and provides a specific technical solution to the problem of inconsistent skill terminology across heterogeneous text sources.

The Normalization Module (216) may assign Importance Weights (334) to each identified skill based on multiple factors derived from the industry operational process documentation. Such factors may include frequency of occurrence, mandatory designation flags, and critical operational process step designations. Frequency of occurrence may be computed by counting how many times a canonical skill identifier appears across Extracted Skills (262) from operational steps within a given Enterprise Input Payload (240). Mandatory flags may be assigned to skills designated as required, mandatory, must-have, or the like in the source documentation, or to skills appearing in operational steps associated with safety, compliance, or quality-control functions. Critical operational process step designations may identify skills associated with key decision points, complex technical operations, or procedures that materially affect output quality or business outcome. In certain embodiments, the importance weight for a skill may be determined using a weighted formula based on a base weight and one or more modifiers corresponding to mandatory status, frequency, and criticality. Mandatory skills may receive greater weight values than non-mandatory skills, such as weight values of at least 1.5 for mandatory skills and approximately 1.0 for non-mandatory skills. The Standardized Required-Skills List (260) generated by the module may include, for each entry, a canonical skill identifier, a source operational process step, an inferred importance weight, and metadata identifying the source document and step sequence for traceability, audit, and logging, thereby defining a concrete data structure produced by the system.

The Skills and Knowledge Identification Module plays a pivotal role in the system by managing the storage, indexing, and structured access to transformed data, ensuring it is readily available for analysis and decision-making. It handles data mapping and schema alignment, aligning educational content with industry requirements to ensure courses cover the relevant skills needed in the workforce. By accurately mapping data, the module ensures educational programs remain aligned with evolving industry demands, equipping students with necessary skills. Additionally, it facilitates loading data into internal knowledge repositories, which serve as centralized storage locations for easy access and retrieval by educators and administrators, supporting efficient curriculum development and academic planning. Real-time query optimization enhances the speed and efficiency of data retrieval, allowing users to access information quickly and without delay, ensuring the system can handle large data volumes and provide timely insights essential for informed decision-making in a fast-paced educational environment. Continuous data health monitoring is another key responsibility, involving regular checks on data accuracy and currency to ensure it remains up-to-date over time. By maintaining data health, the module preserves the integrity of information stored in the system, preventing outdated or incorrect data from impacting decision-making processes. Overall, the Skills and Knowledge Identification Module is integral to maintaining the system's overall functionality and effectiveness, supporting the alignment of academic content with industry needs and ultimately enhancing education quality to prepare students for successful careers.

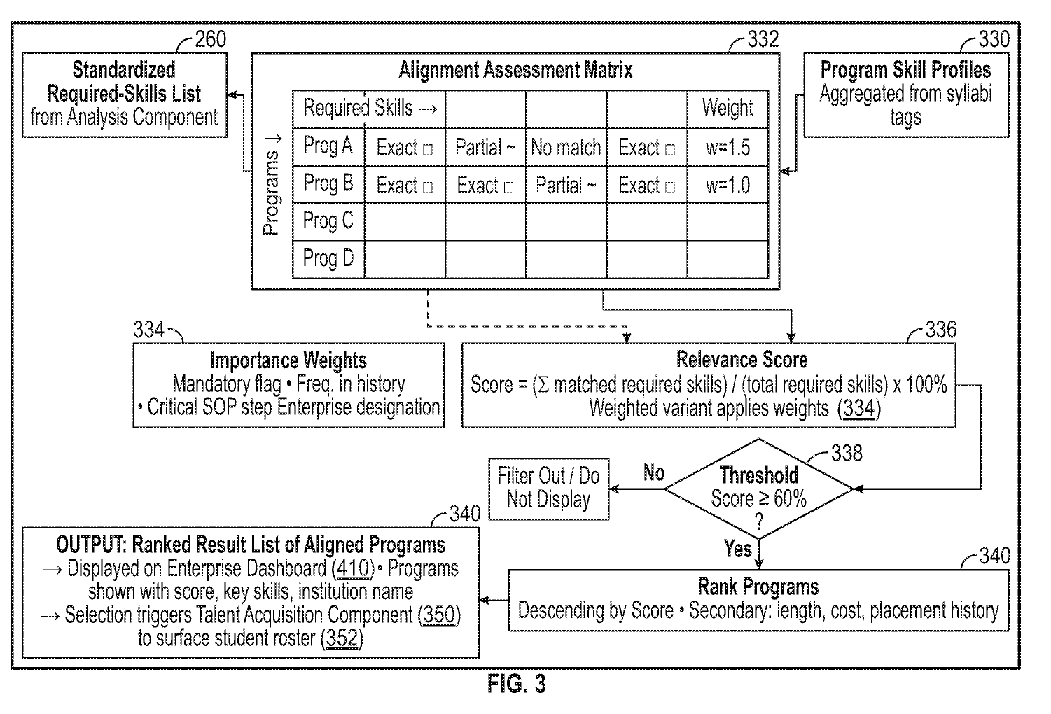

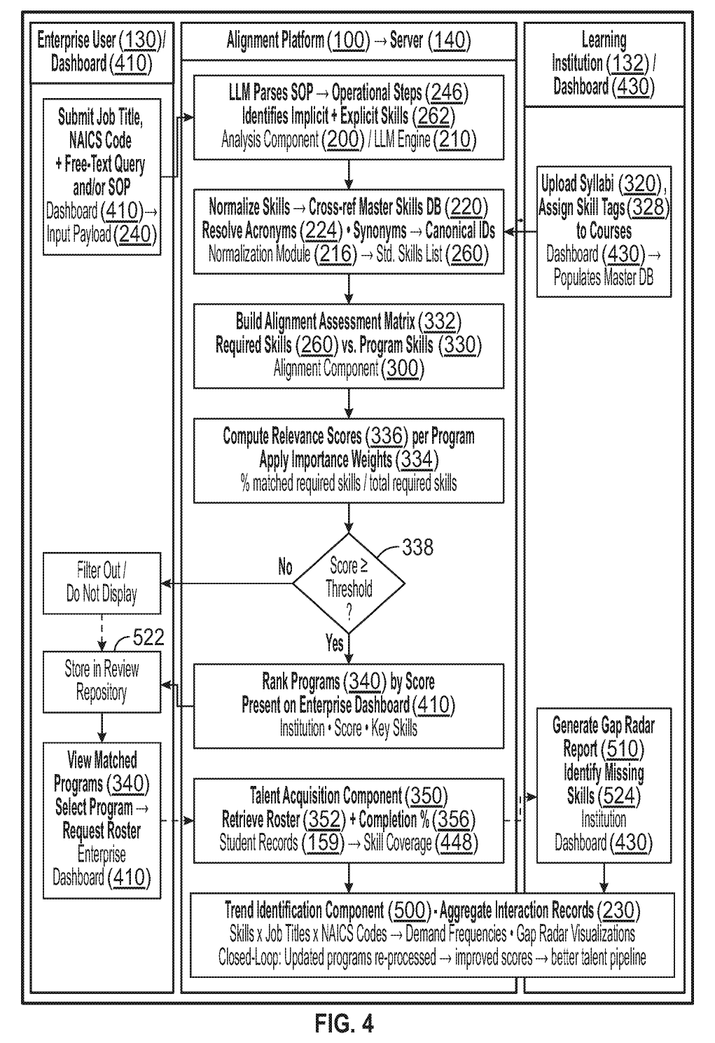

Referring to FIGS. 3 and 4, the Alignment Component (300) plays a critical role in the system by overseeing the operation and interaction between various modules, creating a seamless workflow that extends from data acquisition through to skills identification. Acting as the central hub, it coordinates the flow of data and ensures each module functions harmoniously within the overall system. One of its primary responsibilities is ensuring error correction throughout the data pipeline, identifying and rectifying discrepancies or inaccuracies to maintain data integrity. By implementing robust error correction mechanisms, it prevents flawed data from skewing analysis and insights. Additionally, the Alignment Component manages the timing of data processing activities, ensuring smooth data flow without bottlenecks or delays, thus enabling timely insights for educators and administrators to make informed decisions. Quality control is another essential function, establishing and enforcing high standards for data quality to ensure the information used for analysis is accurate and relevant. This focus on quality control is vital for generating reliable and actionable insights, crucial for guiding curriculum development and ensuring alignment with industry needs. The component's adaptability to changing data and requirements ensures the system remains relevant and effective in a rapidly evolving educational landscape, accommodating new data sources, industry trends, and educational standards. This adaptability allows the system to continuously provide valuable insights reflecting the latest developments in both education and industry.

The Alignment Component (300) may construct an Alignment Assessment Matrix (332) to compare the Standardized Required-Skills List (260) against Program Skill Profiles (330) aggregated from course syllabi and Skill Tags (328). In one embodiment, the Alignment Assessment Matrix is implemented as a data structure in which rows correspond to required skills and columns correspond to academic programs or courses being evaluated. Each cell in the matrix may contain a match score indicating the degree of alignment between a required skill and a program skill profile. An exact match may occur when the canonical identifier of a required skill matches a canonical identifier listed in the program skill profile. A partial match may occur when a required skill and a program skill share a common parent node or other defined relationship in the skills ontology. A non-match may occur when no corresponding entry or qualifying relationship is present. The matrix may store results in a sparse format or another optimized representation so that recomputation may be performed efficiently when Program Skill Profiles (330) are updated. By selectively recalculating only affected matrix entries, the system may avoid recomputing the entire matrix when only a subset of program data changes, thereby improving computational efficiency.

The Alignment Component (300) may compute weighted Relevance Scores (336) for academic programs by applying Importance Weights (334) from the Standardized Required-Skills List (260) to the match scores in the Alignment Assessment Matrix (332). For a given program, the component may retrieve match scores for required skills, multiply individual match scores by corresponding importance weights, and aggregate the weighted values to determine an overall score. In some embodiments, the Relevance Score (336) is calculated as a ratio of the aggregated weighted match score to the sum of the importance weights for the required skills, expressed as a percentage. This weighted approach allows skills designated as mandatory or critical to have a greater impact on the overall score than non-mandatory skills. The Alignment Component (300) may filter out academic programs having Relevance Scores (336) below a predetermined Threshold (338) before transmitting results to the Enterprise Dashboard (410). By excluding low-relevance results from transmission and display, the system may reduce network bandwidth usage and rendering overhead while presenting a more relevant ranked list to enterprise users, thereby providing a specific improvement in network and user-interface performance.

Interfaces tailored to different user categories, such as students, faculty, and administrators, are designed to provide direct access to the platform's comprehensive functionality, ensuring that each user group can effectively engage with the system according to their specific needs. These interfaces are equipped with AI-driven insights that offer valuable data analysis and predictions, helping users make informed decisions. For students, the platform provides personalized feedback and learning recommendations based on their individual progress, learning style, and career aspirations. This personalization helps students stay motivated and focused on their educational goals, offering guidance on courses and skills that align with their future career paths. Faculty members benefit from access to detailed analytics that track student engagement and performance, allowing educators to identify trends, monitor progress, and intervene when necessary to support student success. Faculty can also use the platform to collaborate with colleagues, share resources, and develop innovative teaching strategies that enhance the learning experience. The Talent Acquisition Component (350) may retrieve student rosters (352) from the Relational Database Server (150) for academic programs that meet or exceed the predetermined Threshold (338). For each enrolled student associated with a matched program, the Talent Acquisition Component may calculate a completion percentage based on completed courses relative to total program courses and may cache the calculated values in a fast-access memory structure to reduce repetitive database queries. The Talent Acquisition Component may also determine Skill Coverage Annotations (448) indicating which skills a student has acquired based on completed courses by cross-referencing completed course lists against Skill Tags (328) and comparing the resulting student skill profile against the Standardized Required-Skills List (260) to identify completed, in-progress, and not-started skills. To preserve privacy while enabling talent matching, the Talent Acquisition Component (350) may anonymize student identities by default when roster information is displayed to enterprise users and reveal student identities only upon consent verification through access control rules, thereby implementing a concrete privacy-preserving access-control mechanism in the computing system.

The intelligent query engine, implemented at least in part by the LLM Engine API (210) of FIG. 1, is a pivotal component of the system, designed to enhance user interaction by receiving inputs and interpreting intent through advanced natural language processing (NLP) techniques. This capability allows the system to comprehend and respond to user queries in natural language, making interactions more intuitive and efficient for users such as students, faculty, and administrators. By understanding the nuances of human language, the engine facilitates seamless communication, enabling users to engage with the system without needing specialized technical knowledge.

The engine goes beyond simple query processing by contextualizing responses using the user's prior interaction history. This ensures that the information provided is not only accurate but also relevant to the user's previous interactions, enhancing the personalization of the experience. The query engine intelligently selects appropriate data sources, executes optimized queries, and compiles and ranks results to ensure that users receive the most pertinent information. Responses are then presented in visual or text-based formats, tailored to the user's preferences and needs. This comprehensive approach ensures that users can quickly and efficiently access accurate and relevant information, empowering them to make informed decisions based on the most current data available. By integrating this intelligent query engine, the system supports the alignment of academic content with industry requirements, ultimately enhancing the educational experience and preparing users for success in their respective roles.

Within the proposed system for aligning academic course content with industry requirements, a large language model (LLM) hosted in the AI Services Layer (160) and exposed through the LLM Engine API (210), such as a generative transformer-based engine, is integral in converting query outputs into natural language responses. This advanced technology significantly enhances the user interface by generating context-aware, conversational responses tailored for reports, alerts, summaries, and educational support. By doing so, the LLM allows users, including students, faculty, and administrators, to interact with the system in a more intuitive and engaging manner, thereby improving the overall user experience. The model's ability to understand and generate human-like text ensures that complex data is presented in a clear and comprehensible way, making it more accessible to all users.

The LLM's capability to deliver clear and concise responses is particularly beneficial in helping users understand intricate information and make informed decisions regarding curriculum development and alignment with industry needs. For instance, it can provide a summary of industry trends, alert educators to changes in skill requirements, or offer students guidance on course selections that align with their career aspirations. This integration of advanced language processing technology sets the system apart from traditional educational platforms by offering a more dynamic and responsive user experience. By leveraging the power of LLMs, the system not only enhances communication but also supports the alignment of academic content with industry requirements, ultimately contributing to a more effective and engaging educational environment that prepares students for success in their careers.

In alternative embodiments, the system may be enhanced with a variety of additional features to further improve its functionality and adaptability to evolving industry and academic needs. One such enhancement could involve equipping the Analysis Component (200) with machine learning algorithms. These algorithms would enable the system to learn from past data and improve its accuracy in identifying the necessary skills and knowledge requirements from industry documentation. By leveraging machine learning, the system could adapt to new terminologies and industry-specific jargon, thereby increasing its precision in pinpointing relevant skills. This would ensure that the Analysis Component remains effective even as industry documentation evolves. Additionally, the Alignment Component (300) could be upgraded to utilize advanced data analytics techniques. This would refine the relevance scoring process, allowing for more nuanced and sophisticated comparisons between course content and industry needs. By employing data analytics, the system could consider a wider range of factors when determining relevance scores, such as the context in which skills are applied or the interdependencies between different knowledge areas. This would result in a more comprehensive evaluation of how well academic courses align with industry requirements.

Moreover, the Trend Identification Component (500) could be enhanced by integrating real-time data feeds. This would allow the system to continuously update trends in skill and knowledge requirements, ensuring that it remains responsive to rapid changes in industry demands. By accessing real-time data, the system could quickly identify emerging trends and adjust its recommendations accordingly, providing academic institutions with timely insights into the skills that are becoming increasingly important in the workforce. The Review Component could also be expanded to include collaborative tools, enabling academic users to work together within the academic review repository. These tools could facilitate communication and collaboration among educators, allowing them to collectively develop curricula that are more closely aligned with emerging industry trends. This collaborative approach would ensure that curriculum development is informed by a diverse range of perspectives and expertise. Furthermore, the storage and access component might be enhanced with advanced security features to protect sensitive industry and academic data. By implementing robust security measures, the system could ensure that only authorized users have access to its functionalities, safeguarding the confidentiality and integrity of the data it processes.

In additional embodiments, the platform extends the same skills extraction and normalization pipeline employed by the Analysis Component (200) to support enterprise talent search. After the Analysis Component (200) produces the Standardized Required-Skills List (260) from the Enterprise Input Payload (240), the Alignment Component (300) is configured to apply the Alignment Assessment Matrix (332), the Importance Weights (334), the Relevance Score (336), and the Threshold (338) not only to Program Skill Profiles (330) aggregated from learning-institution syllabi, but also to professional skill profiles derived from individual professionals and to training-track skill profiles derived from workforce development partners, as further described below.

In one such embodiment, the platform supports a category of independent professional users having a dedicated dashboard accessible through user terminals analogous to the terminals shown in FIG. 1. The independent professional dashboard permits a professional user to create and maintain a resume or professional profile comprising work history, role descriptions, projects, certifications, and similar information. The Analysis Component (200) processes the resume or professional profile using the Pre-Processing Module (214) and the LLM Processing Engine (210) to identify Extracted Skills (262) from the professional's submission, and the Normalization Module (216) cross-references the extracted skills against the Master Skills Database (220) to produce a normalized professional skill profile. The Alignment Component (300) then applies the Alignment Assessment Matrix (332) to compare the normalized professional skill profile against the Standardized Required-Skills List (260) of an enterprise request, computes a Relevance Score (336), and presents matching professionals through the Talent Acquisition Component (350). The same processing pipeline may be applied to professionals identified through any other source maintained by the platform.

In a further embodiment, the platform supports a category of workforce development partners that is treated analogously to a learning institution. A workforce development partner accesses the platform through an interface analogous to the Institution Dashboard (430) and uploads training materials, training-track descriptions, and associated skill tags in the same manner that a learning institution uploads syllabi and assigns Skill Tags (328) to courses. The platform aggregates the workforce partner's training-track content into training-track skill profiles in the same manner as Program Skill Profiles (330) are aggregated from institution syllabi. The Alignment Component (300) compares the training-track skill profiles against the Standardized Required-Skills List (260) using the Alignment Assessment Matrix (332), the Importance Weights (334), the Relevance Score (336), and the Threshold (338) in the same manner as for institution programs. Training-track candidates may be surfaced through the Talent Acquisition Component (350) using the same Roster (352), Completion percentage (356), and Skill Coverage (448) mechanisms described above.

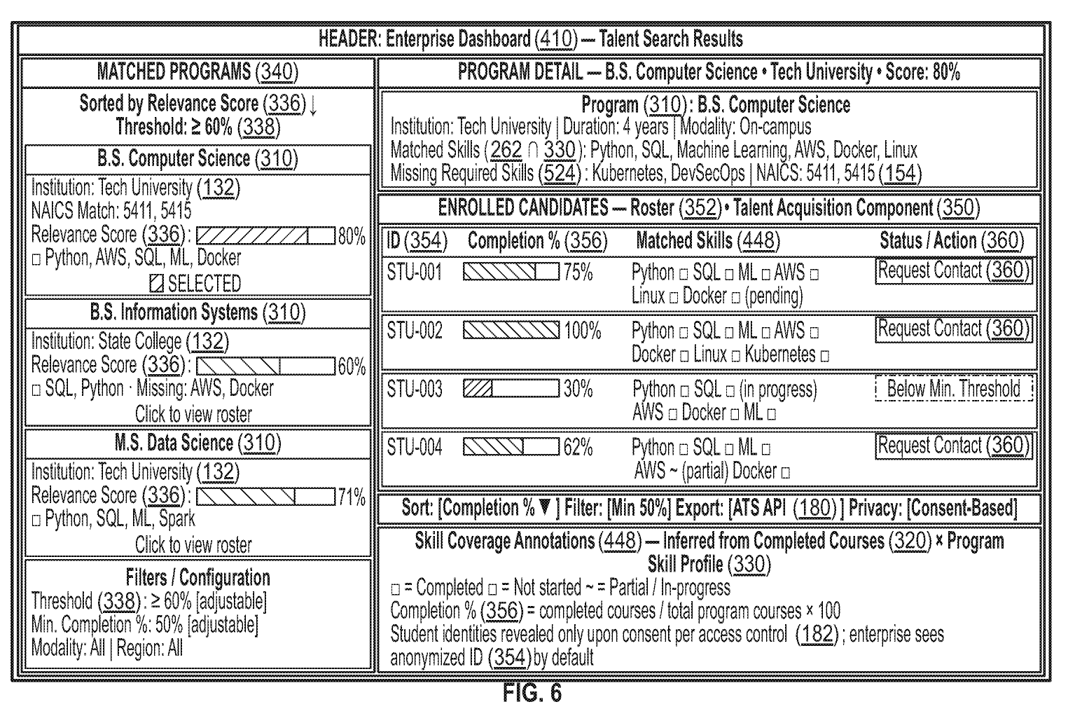

In response to an enterprise request submitted through the Enterprise Dashboard (410), the platform returns two separate ranked lists. The first list comprises professionals matched to the Standardized Required-Skills List (260), including independent professionals having professional profiles maintained on the platform and candidates enrolled in workforce development training tracks, presented with their respective Relevance Scores (336) and skill coverage information consistent with the Skill Coverage Annotations (448) shown in FIG. 6. The second list comprises learning-institution programs and workforce development training tracks ranked by their respective Relevance Scores (336), presented with institution or workforce-partner identification, key matched skills, and an indication of any Missing Skills (524) for Gap Radar reporting. The two lists may be displayed concurrently on the Enterprise Dashboard (410) or independently selected by the enterprise user, and selection of either list element triggers the corresponding downstream action of the Talent Acquisition Component (350) or program review.

Although specific embodiments have been described in detail, it should be understood that various modifications, substitutions, and alterations may be made without departing from the scope of the system as defined in the appended claims. This catch-all legal language ensures that the description remains flexible and open to future innovations and improvements, allowing the system to evolve alongside changes in educational and industry landscapes. By accommodating potential modifications, the system is positioned to remain relevant and effective in a rapidly changing world, ensuring that it continues to meet the needs of educators, learners, and administrators alike.

1. A system for aligning academic course content to current or future industry skill and knowledge requirements, comprising:
an analysis component configured to analyze industry operational process documentation using natural language processing to identify skills and knowledge requirements and generate a standardized required-skills list with importance weights;
a master skills database comprising canonical skill nodes with associated relationships and mappings for skill normalization;
an alignment component configured to compare the skills and knowledge requirements with course educational content using an alignment assessment matrix to compute weighted relevance scores based on the importance weights, rank a plurality of course descriptions based on their respective relevance scores, and list the plurality of course descriptions in order of their relevance scores;
a trend identification component configured to identify trends in skill and knowledge requirements based on patterns determined from the industry operational process documentation; and
a review component configured to determine that a relevance score for a course description is below a predetermined threshold and move the industry operational process documentation corresponding to the relevance score to an academic review repository.

2. The system of claim 1, wherein the industry operational process documentation comprises at least one of a free-text query, standard operating procedures, work instructions, or job title information.

3. The system of claim 1, wherein the analysis component comprises a pre-processing module configured to perform tokenization, natural language processing, and standard operating procedure step segmentation on the industry operational process documentation to extract operational steps and identify skills, wherein the segmentation reduces computational processing requirements by limiting input context length for subsequent analysis.

4. The system of claim 3, wherein the analysis component further comprises a large language model processing engine configured to identify implicit skills and explicit skills from the operational steps and perform context disambiguation using job title information, thereby providing automated skill extraction that solves the technical problem of inconsistent skill terminology across different industries and enterprises.

5. The system of claim 4, wherein the large language model processing engine performs implicit skill identification by inferring skills that are required but not explicitly stated in the operational process documentation based on context provided by job title, thereby identifying skills that human reviewers would require additional domain expertise to recognize.

6. The system of claim 1, wherein each canonical skill node in the master skills database is associated with aliases, synonyms, relationships to other canonical skill nodes, and industry mappings, wherein the master skills database stores standard terminology in a skills ontology for skill normalization, and wherein the skills ontology defines hierarchical relationships between skills to enable cross-referencing of industry-specific terminology variants.

7. The system of claim 6, further comprising a normalization module configured to resolve acronyms in extracted skills, map the extracted skills to canonical skill identifiers in the master skills database through synonym resolution using the skills ontology, and assign the importance weights to each identified skill based on at least one of frequency of occurrence in the industry operational process documentation, mandatory flags, or critical operational process step designations.

8. The system of claim 7, wherein the normalization module generates the standardized required-skills list comprising canonical skill identifiers, source operational process steps, and inferred importance weights, and wherein each entry in the standardized required-skills list includes metadata identifying the source document and step number for audit traceability.

9. The system of claim 7, wherein the normalization module traverses the hierarchical relationships in the skills ontology to map variant skill terminology to standardized canonical skill identifiers, thereby enabling automated cross-industry skill normalization without manual intervention.

10. The system of claim 1, wherein the alignment component applies the importance weights to compute the weighted relevance scores for each academic program by calculating matched required skills divided by total required skills and applying weight values to individual skill matches, and wherein the alignment component filters out academic programs with relevance scores below the predetermined threshold from display to reduce network bandwidth and computational resources by eliminating low-relevance results.

11. The system of claim 10, wherein the alignment component applies the importance weights by multiplying individual skill match scores by corresponding weight values before aggregating to compute the weighted relevance scores, and wherein mandatory skills are assigned weight values of at least 1.5 while non-mandatory skills are assigned weight values of 1.0.

12. The system of claim 10, wherein the alignment assessment matrix compares required skills against program skill profiles aggregated from course syllabi and skill tags to determine exact matches, partial matches, and non-matches for each academic program, and wherein the alignment assessment matrix stores match results in matrix form to enable rapid recomputation when program curricula are updated.

13. The system of claim 1, further comprising a talent acquisition component configured to retrieve student rosters associated with academic programs that meet the predetermined threshold from a relational database server, wherein the talent acquisition component displays completion percentages for enrolled students and skill coverage annotations indicating which skills each student has acquired based on completed courses, and wherein the talent acquisition component calculates the completion percentages as completed courses divided by total program courses and caches the calculated values to reduce database query load.

14. The system of claim 13, wherein the talent acquisition component displays student identifiers, completion percentages, matched skills for each student, and status indicators showing whether skills are completed, not started, or partially in progress, and wherein student identities are anonymized by default and revealed only upon consent per access control rules to preserve privacy while enabling talent matching.

15. The system of claim 1, further comprising a gap analysis component configured to compare skill demand frequencies from the trend identification component with program skill profiles to identify missing skills that are present in enterprise demand but absent or underrepresented in academic program coverage, generate gap analysis reports comprising high-demand missing skills and recommended curriculum actions, and generate gap radar visualizations displaying skill demand versus program coverage as graphical representations rendered through an institution dashboard interface.

16. A computer-implemented method for aligning academic course content to current or future industry skill and knowledge requirements, the method comprising:
analyzing, by an analysis component, industry operational process documentation using natural language processing to identify skills and knowledge requirements and generate a standardized required-skills list with importance weights;
comparing, by an alignment component, the skills and knowledge requirements with course educational content using an alignment assessment matrix to compute weighted relevance scores based on the importance weights;
ranking, by the alignment component, a plurality of course descriptions based on their respective relevance scores;
listing, by the alignment component, the plurality of course descriptions in order of their relevance scores;
identifying, by a trend identification component, trends in skill and knowledge requirements based on patterns determined from the industry operational process documentation; and
determining, by a review component, that a relevance score for a course description is below a predetermined threshold and moving the industry operational process documentation corresponding to the relevance score to an academic review repository.

17. The method of claim 16, wherein analyzing comprises performing tokenization, natural language processing, and standard operating procedure step segmentation on the industry operational process documentation to extract operational steps, identifying implicit skills and explicit skills from the operational steps using a large language model processing engine with context disambiguation based on job title information, and normalizing identified skills by mapping the identified skills to canonical skill identifiers in a master skills database comprising a skills ontology through synonym resolution, thereby providing automated skill extraction that solves the technical problem of inconsistent skill terminology across different industries and enterprises.

18. The method of claim 17, wherein the large language model processing engine performs implicit skill identification by inferring skills that are required but not explicitly stated in the operational process documentation based on context provided by job title, thereby identifying skills that human reviewers would require additional domain expertise to recognize, and wherein the skills ontology defines hierarchical relationships between canonical skill nodes that are traversed to map variant skill terminology to standardized canonical skill identifiers.

19. The method of claim 16, wherein comparing comprises applying the importance weights to compute the weighted relevance scores for each academic program by calculating matched required skills divided by total required skills and applying weight values to individual skill matches, wherein mandatory skills are assigned weight values of at least 1.5 while non-mandatory skills are assigned weight values of 1.0, and wherein applying the weight values comprises multiplying individual skill match scores by corresponding weight values before aggregating, and further comprising filtering out academic programs with relevance scores below the predetermined threshold to reduce network bandwidth and computational resources.

20. The method of claim 16, further comprising retrieving, by a talent acquisition component, student rosters associated with academic programs that meet the predetermined threshold from a relational database server, displaying completion percentages calculated as completed courses divided by total program courses with cached values to reduce database query load, displaying skill coverage annotations indicating which skills each student has acquired based on completed courses with student identities anonymized by default and revealed only upon consent per access control rules, comparing, by a gap analysis component, skill demand frequencies with program skill profiles to identify missing skills, generating gap radar visualizations displaying skill demand versus program coverage as dynamically updated graphical representations, and providing access to the gap radar visualizations through an institution dashboard interface with filtering controls for adjusting threshold values, minimum completion percentages, modality, and geographic region.
